(19) United States
(12) Patent Application Publication
(10) Pub. No.: US 2016/0350957 A1
(43) Pub. Date: Dec. 1, 2016

(54) Multitrack Virtual Puppeteering

(71) Applicants: Andrew Woods, Seattle, WA (US); Matthew Scott, Redmond, WA (US)

(72) Inventors: Andrew Woods, Seattle, WA (US); Matthew Scott, Redmond, WA (US)

(21) Appl. No.: 15/166,057

(22) Filed: May 26, 2016

Related U.S. Application Data
(60) Provisional application No. 62/166,249, filed on May 26, 2015.

(51) Int. Cl. G06T 13/40

(52) U.S. Cl. CPC G06T 13/40

(57) ABSTRACT

A multichannel virtual puppetry device for creating a single virtual character performance one character feature at a time by building up layers of puppeteered animation. The device has a 2D input square particularly mapped for each feature channel. Dimensions of expression for a selected expression for a selected feature for each channel are driven by XY coordinates of the input.

This application claims priority to U.S. Provisional Application 62/166,249 filed May 26, 2015.

### TECHNICAL FIELD

This disclosure relates to the virtual puppeteering; more particularly it relates to multitrack visual engineering in a graphic space.

### BACKGROUND

Existing approaches to 3D computer animation tend to draw from two common methods:

Hand keyframing: Separate elements are posed at different places in the time line. The animator can jump around in time, editing individual poses and the tangents of motion through those poses, with the computer automatically calculating the poses between those that are explicitly set.

Full body performance capture: Here, the skeletal animation for an entire character or even multiple characters is captured all at once in real time at a given frame rate. Actual humans are generally fitted with one of a growing variety of suits full of sensors or markers, and the process then records the positions of each of these sensors in 3D space as the performance is recorded. Usually, hand keyframing is then required to cleanup and flesh out details as performance captured animations are finalized.

Of course, some work flows have attempted to combine these methods in interesting ways:

In a relatively recent approach (http://www.wired.co.uk/news/archive/201406/30/input puppets), a physical skeleton of sensors was created, and connected to the virtual character in the computer. The animator can use this skeleton to pose the character and capture keyframes as desired, bringing more of a stop motion approach to the non linear hand keyframing process.

Animators have also used more limited performance capture setups (sensors on a small number of joint locations (arm and hand/fingers, for example), allowing the live puppeteering of an avatar in real time.

Here is a more recent sensor less example: https://vimeo.com/110452298

Here is a section on the general strengths of and reasons for this kind of approach:

https://books.google.com/books?id=pskqBgAAQBAJ&pg=PA172&lpg=PA172&dq=hand+puppeteering+of+digital+character&source=bl&ots=Y7LCbJAl&sig=BrB2Nw08dBRXwarGbMEbDHutHAw&hl=en&sa=X&ei=etU3Vf6nKtHnoAT75oBI&ved=0CCkQ6AEwAg#v=onepage&q=hand%20puppeteering%20of%20digital%20character&f=false)

The puppeteer's hand might be mapped to the avatar's head and his fingers mapped to various facial features for instance. Often the computer is then used to supplement this performance by procedurally animating various secondary elements (cloth simulations/bouncing antennae/etc. . . . ).

### DISCLOSURE

In the disclosed process, each character feature is performance captured (“puppeteered”) separately, in a layering process. (This process may in some ways be analogous to multitrack audio recording.) The puppeteering is easy and accessible, since only one feature is being input at a time and the results are seen in realtime. The cumulative result is a fully animated character.

For reference in the following sections, our current list of capture able channels/features is: head rotation, head lean, neck rotation, body rotation, body lean, body position, mouth shape, mouth emotion, eye look, brow master, brow right detail, brow left detail, eyelid bias, eyelid closed amount, and blink.

One Feature at a Time:

While it is normal to manipulate a single feature/channel at a time in hand keyed animation, it is new to break up performance capture in this way. In our process, it's not just a matter of compositing separately captured characters into the same scene. Nor is it a matter of splicing multiple takes of a scene into a single performance. Instead, a single character performance is created by building up layers of puppeteered animation—one character feature at a time.

Custom Input Mapping Per Feature:

For each ‘pass’, the same 2D input space on the device (the input rectangle) is mapped to a single feature of the puppet in an intuitive way. The mapping is not generalized, as in 3D software packages—where dragging a widget in a given direction produces the same transformation on each object. Instead, the 2D input square has been particularly mapped for each channel, so that the most important dimensions of expression for that feature are driven by the XY coordinates of the input.

For instance, in animating the head, the X axis maps to head “turn” and the Y axis maps to “nod”, with the generally less important head “lean” separated out as an advanced channel. For “eye blink”, tapping the pad produces a blink that lasts as long as the finger is down. For the simplified “mouth emotion” channel, moving to the right side of the input rectangle layers in a smile, while moving to the left side layers in a frown. And so on, across each animatable feature and its corresponding channel. In this way, simple 2 dimensional gestures are compounded into an animated action for the whole character. And because each feature responds in real time to movement within the input rectangle (comparable to a physical joy stick), the way that this input is retargeted for that specific feature is transparent to the user.

This allows new untrained users to intuitively control each feature of the puppet in less than a minute, with no verbal/explicit training.

Coordination by Looping:

Each pass is captured in real time as the soundtrack (usually a line of dialogue) is played back. In this way, the soundtrack becomes the time line of the work. Channels are not captured simultaneously as in usual motion capture setups. However, the fact that each channel is captured against, and retains its temporal relationship relative to, the same soundtrack allows for intuitive coordination between the various performance tracks.

During each pass, the soundtrack and any previously captured channels are played back while the new channel is driven in response to the user's gestures in the input zone. The soundtrack and the growing list of channels that have already been captured serve as the slowly evolving context for each new pass, helping to integrate them into a single cohesive character performance.

### BRIEF DESCRIPTION OF THE DRAWINGS

FIG. 1 is a screenshot display for InputMappingBlinkOff

FIG. 2 is a screenshot display for InputMappingBlinkOn

FIG. 3 is a screenshot display for InputMappingBodyPositionDown

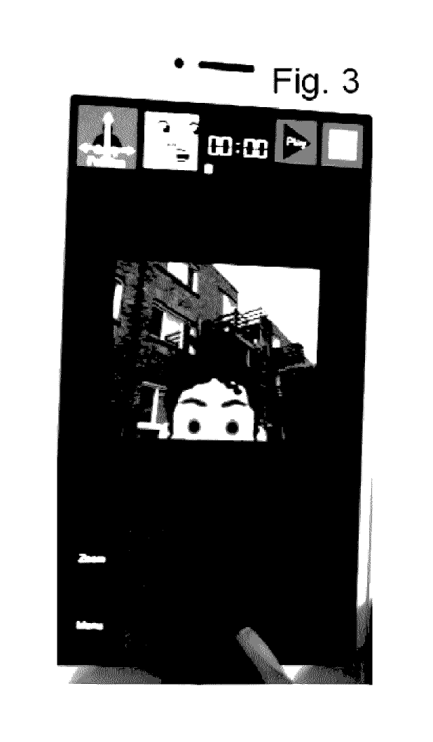

FIG. 4 is a screenshot display for InputMappingBodyPositionLeft

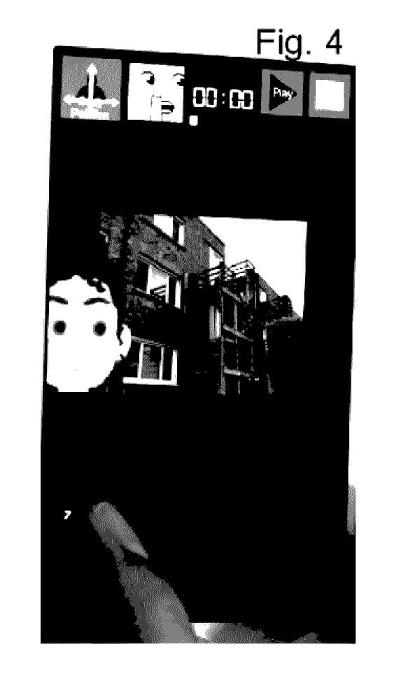

FIG. 5 is a screenshot display for InputMappingBodyPositionRight

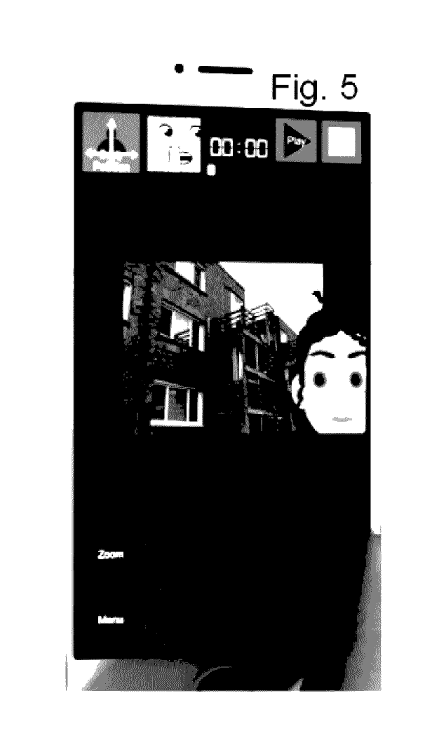

FIG. 6 is a screenshot display for InputMappingBodyPositionUp

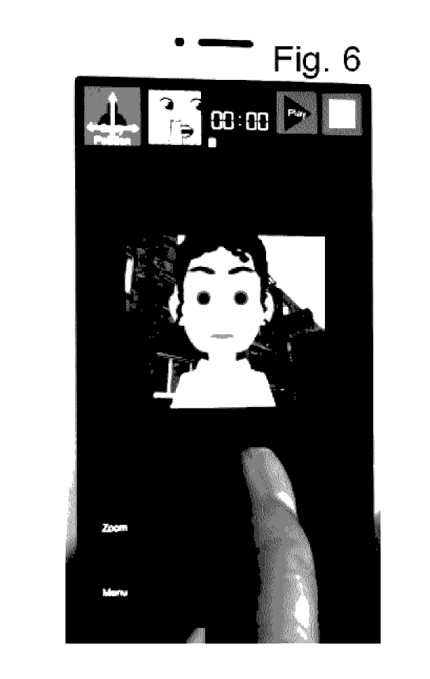

FIG. 7 is a screenshot display for InputMappingBrowsDown

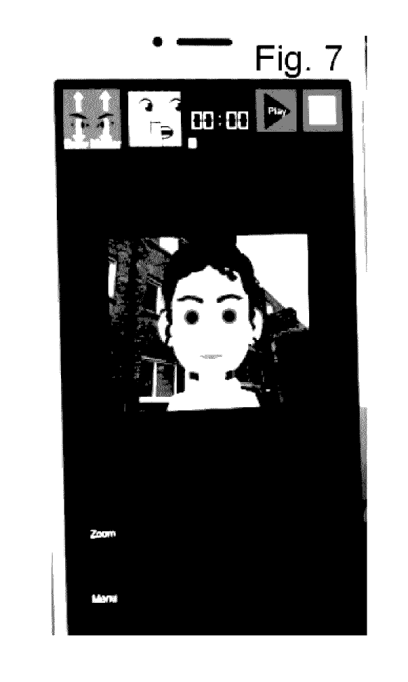

FIG. 8 is a screenshot display for InputMappingBrowsUp

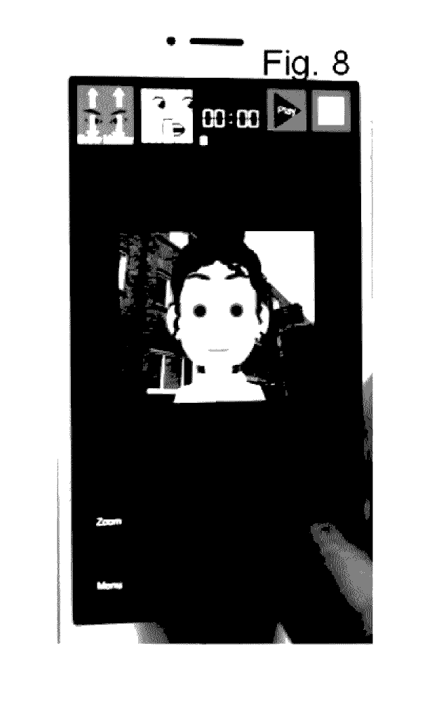

FIG. 9 is a screenshot display for InputMappingEyelidBiasDown

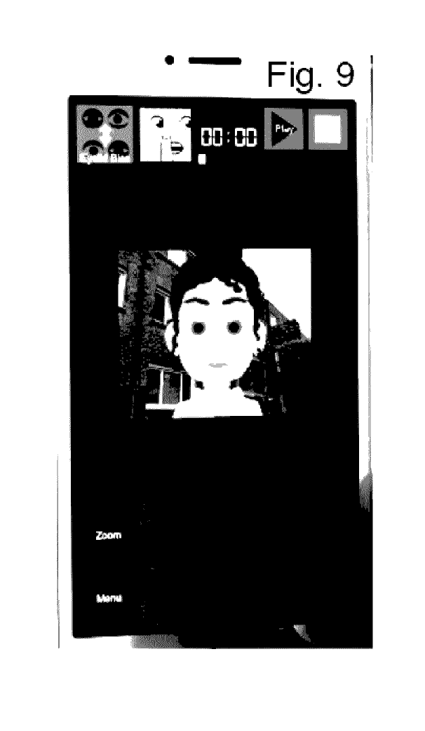

FIG. 10 is a screenshot display for InputMappingEyelidBiasLeft

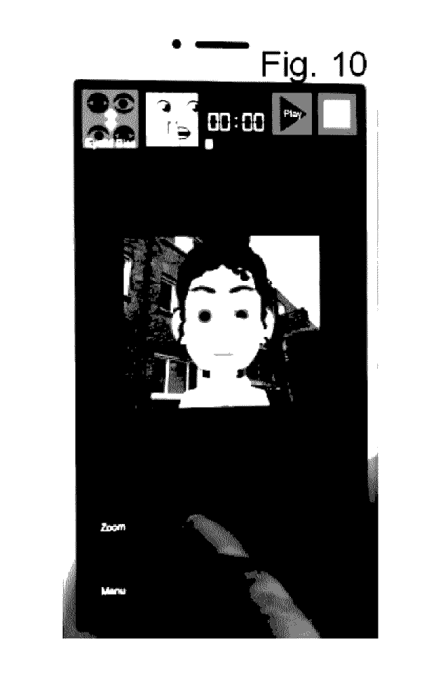

FIG. 11 is a screenshot display for InputMappingEyelidBiasRight

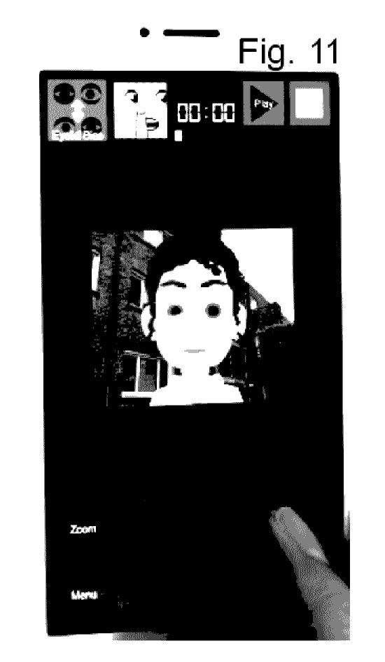

FIG. 12 is a screenshot display for InputMappingEyelidBiasUp

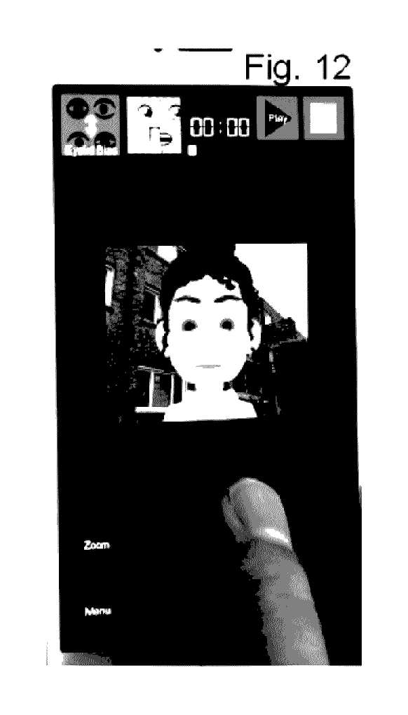

FIG. 13 is a screenshot display for InputMappingHeadLeanLeft

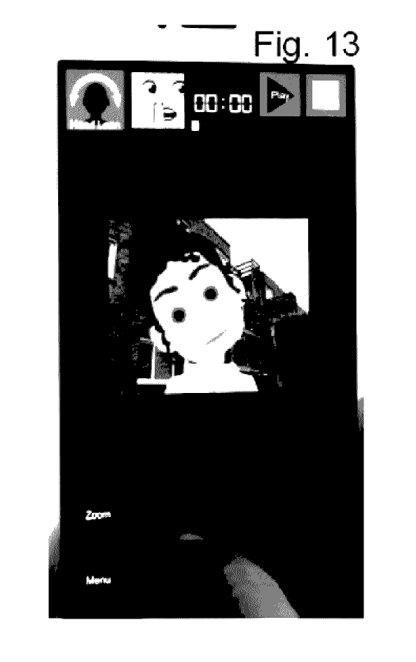

FIG. 14 is a screenshot display for InputMappingHeadLeanRight

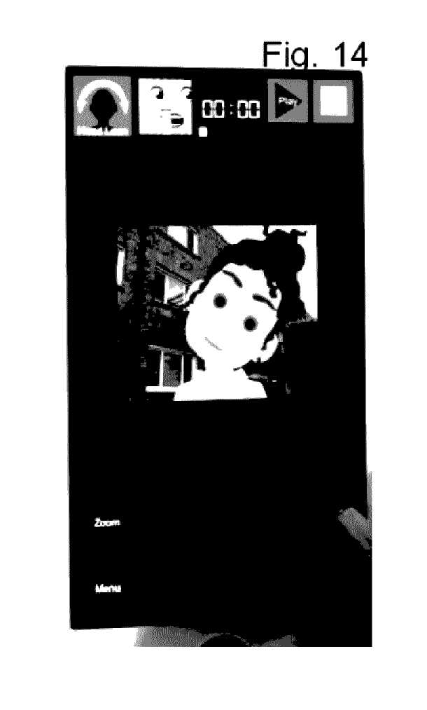

FIG. 15 is a screenshot display for InputMappingHeadRotationDown

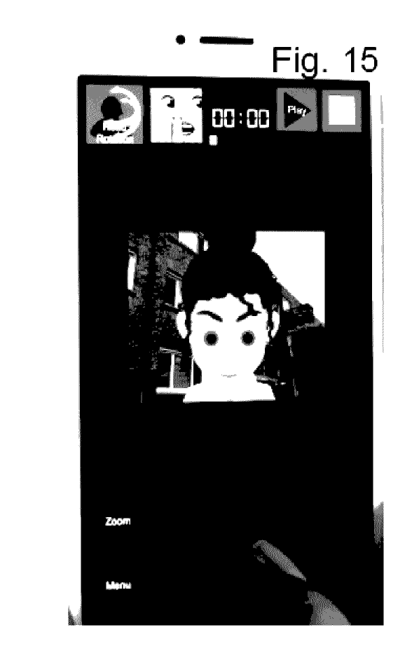

FIG. 16 is a screenshot display for InputMappingHeadRotationLeft

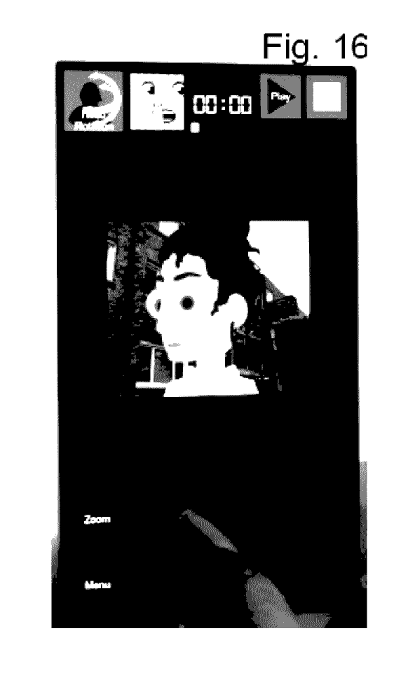

FIG. 17 is a screenshot display for InputMappingHeadRotationRight

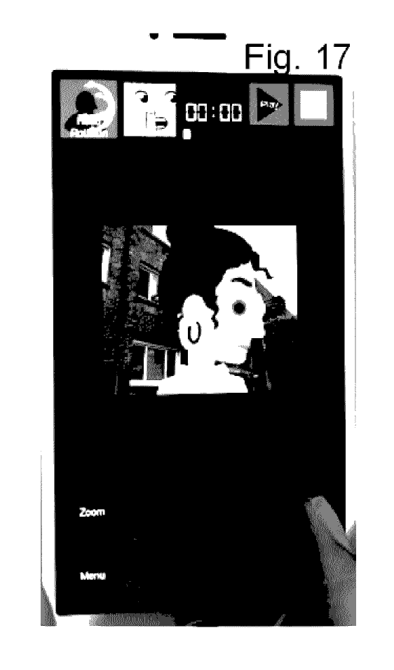

FIG. 18 is a screenshot display for InputMappingHeadRotationUp

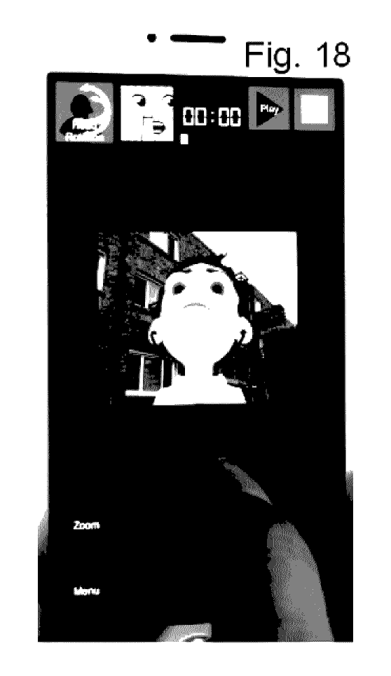

FIG. 19 is a screenshot display for Layering01Start

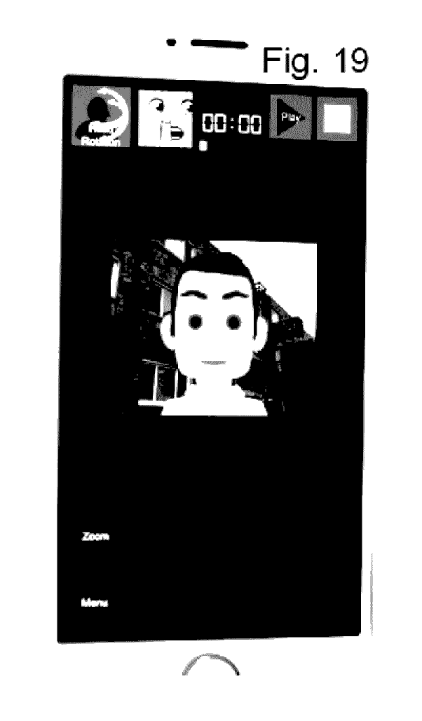

FIG. 20 is a screenshot display for Layering02TrackOptions

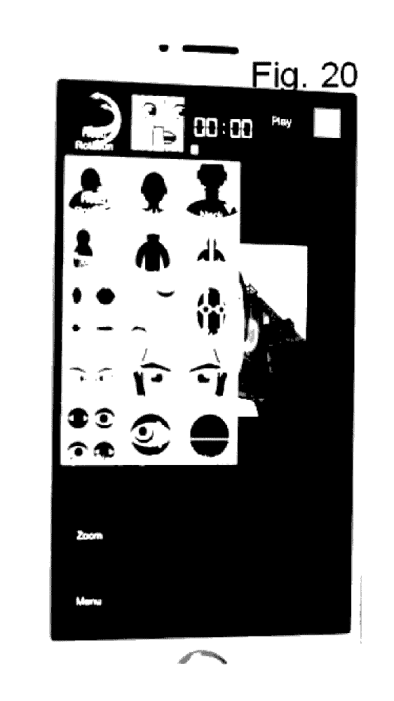

FIG. 21 is a screenshot display for Layering03BodyPosition

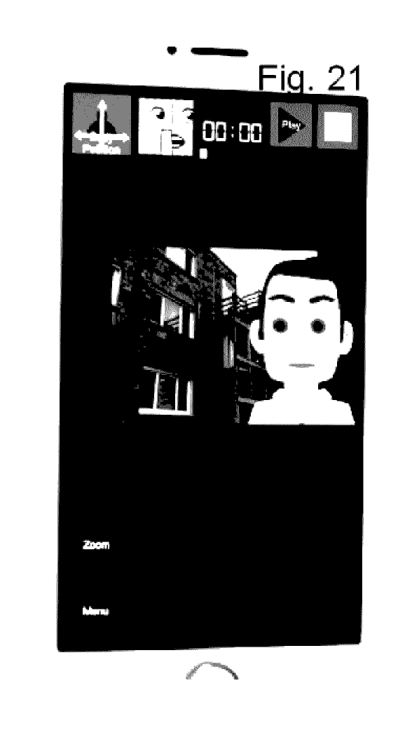

FIG. 22 is a screenshot display for Layering04BodyRotation

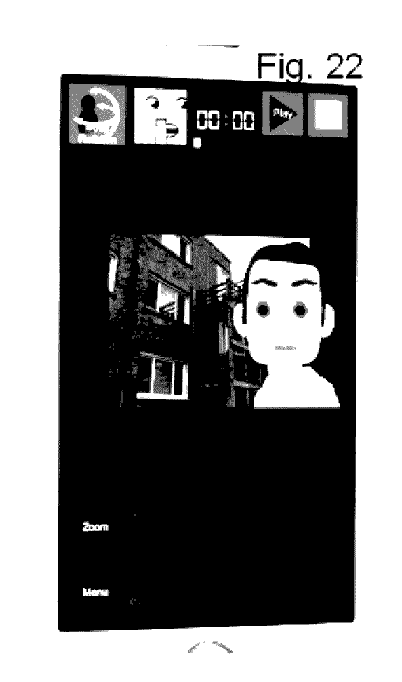

FIG. 23 is a screenshot display for Layering05HeadRotation

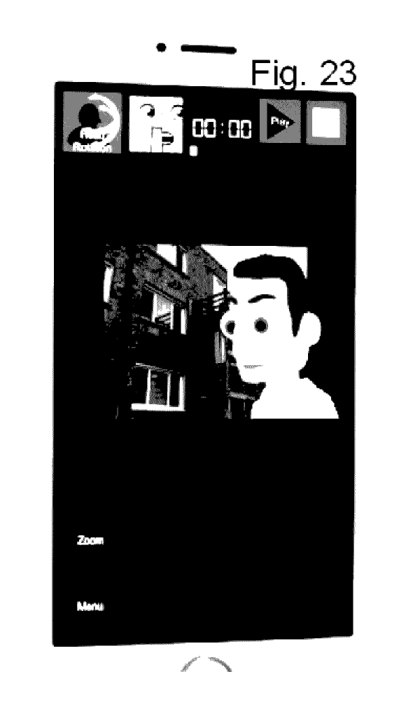

FIG. 24 is a screenshot display for Layering06NeckRotation

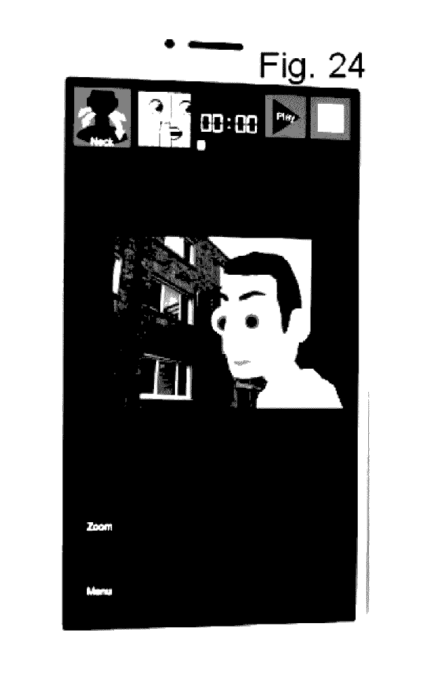

FIG. 25 is a screenshot display for Layering07HeadLean

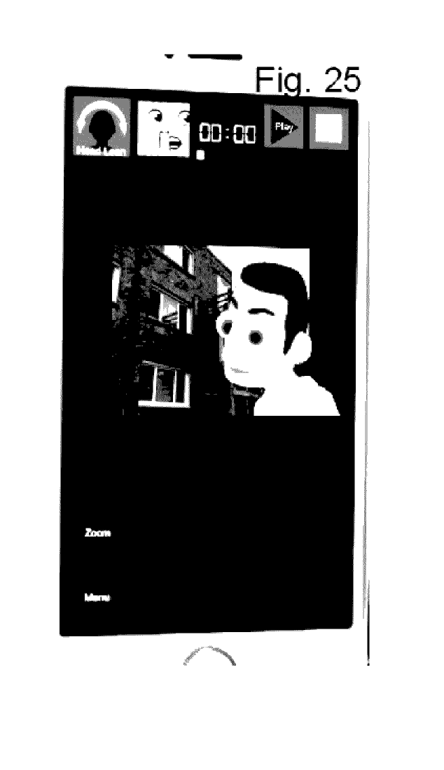

FIG. 26 is a screenshot display for Layering08EyelookAdded

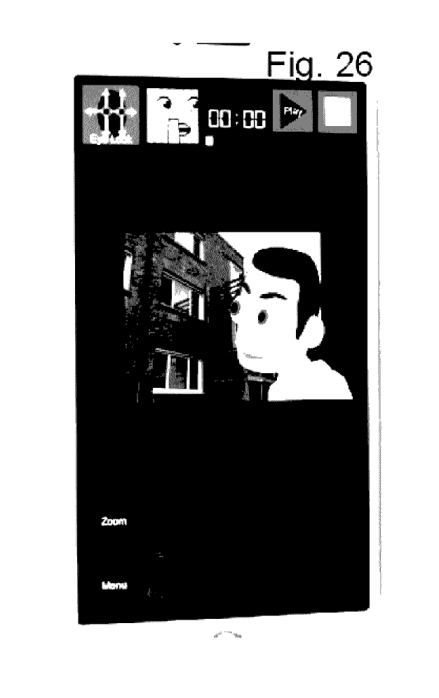

FIG. 27 is a screenshot display for Layering09EyelidClosedAmount

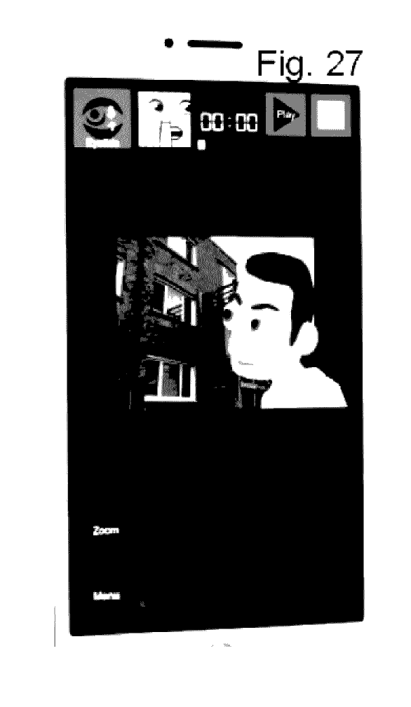

FIG. 28 is a screenshot display for Layering10EyelidBias

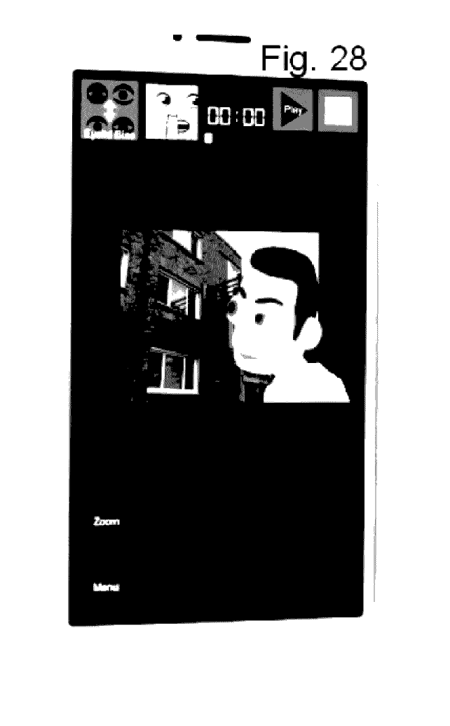

FIG. 29 is a screenshot display for Layering11Brows

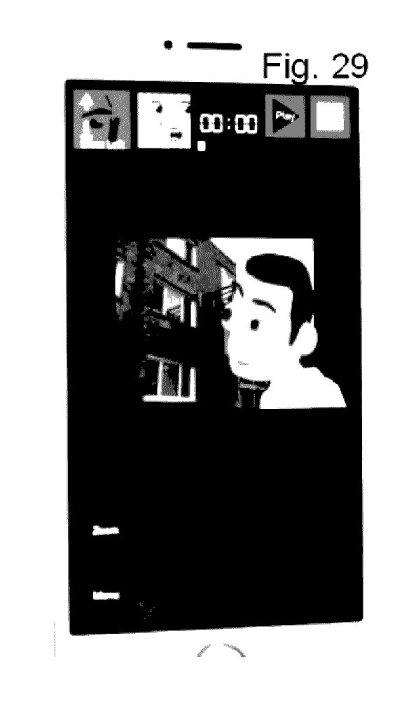

FIG. 30 is a screenshot display for Layering12MouthEmotion

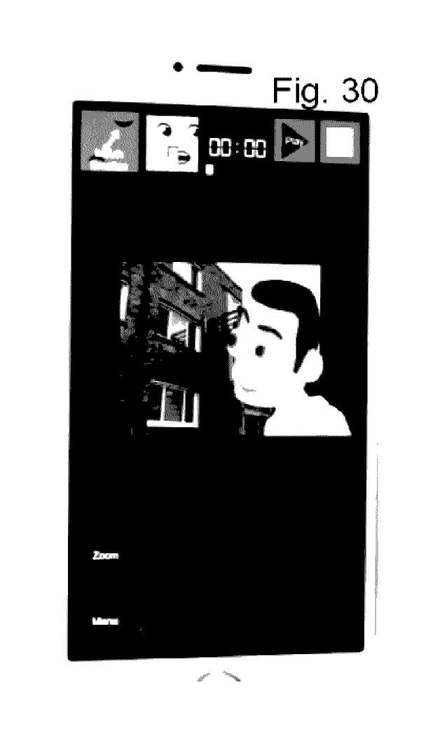

### DETAILED DESCRIPTION

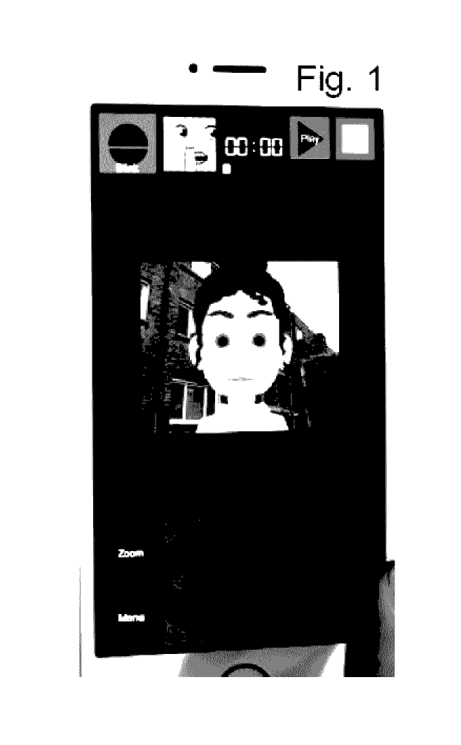

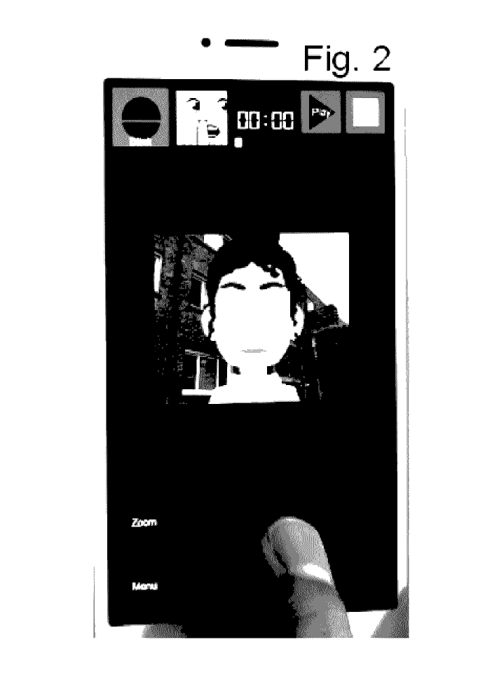

The screenshots which comprise the Figures of the application are, in accordance with the foregoing disclosure, at least partially descriptive of each one of the respectively presented drawing figure screenshots. Thus, for instance, FIG. 1 is a description for the first of the drawing figure screenshots, while FIG. 2 et seq are the respective descriptions for the second of the drawing figure screenshots, and so forth.

We claim:

1. A multichannel virtual puppetry device for creating a single virtual character performance one character feature at a time by building up layers of puppeteered animation;
the device comprising a 2D input square particularly mapped for each feature channel, wherein dimensions of expression for a selected expression for a selected feature for each channel are driven by XY coordinates of the input.
